(19) United States
(12) Patent Application Publication
(10) Pub. No.: US 2005/0066758 A1
(43) Pub. Date: Mar. 31, 2005

(54) Transmission

(76) Inventors: Frederick W. Marcell, Naples, FL (US); Russell A. Rybicki, Lakewood, OH (US); Gerhard Plamper, Cleveland, OH (US)

Correspondence Address: JOSEPH G CURATOLO, ESQ.;CURATOLO SIDOTI CO. LPA, 24500 CENTER RIDGE ROAD, SUITE 280, CLEVELAND, OH, 44145, US

(21) Appl. No.: 10/955,744

(22) Filed: Sep. 30, 2004

Related U.S. Application Data
(60) Provisional application No. 60/507,449, filed on Sep. 30, 2003.
(60) Provisional application No. 60/507,355, filed on Sep. 30, 2003.

(51) Int. Cl. F16H 57/08

(52) U.S. Cl. 74/425

(57) ABSTRACT

A transmission includes a housing and a gear assembly supported by the housing. The gear assembly includes a shaft carried by the housing, a bull gear attached to the shaft, and a helical gear shaft carried by the housing. The helical gear shaft incorporates a helical gear operatively connected to the bull gear. The transmission can be either a single-speed transmission or a variable-speed transmission. The single speed transmission employs a pulley attached to the helical gear shaft, and a belt wrapped around the pulley. The variable-speed transmission employs a driven pulley supported by the helical gear shaft, an idler pulley pivotably attached to the housing, and a belt wrapped around the driven pulley and the idler pulley.

### CROSS-REFERENCE TO RELATED APPLICATIONS

This application claims the benefit of the filing date of U.S. Provisional Applications Ser. Nos. 60/507,355 and 60/507,449, both filed on Sep. 30, 2003.

### TECHNICAL FIELD

The present invention relates to transmissions useful for use with a lawnmower.

### BACKGROUND

Transmissions have long been used to drive the front and rear wheels of lawnmowers. Such transmissions, however, have had difficulty in providing an efficient transfer of torque using a belt wound between a drive pulley attached to a lawnmower engine and a driven pulley. For example, assuming the drive pulley is rotating at a constant speed, the driven pulley attached to the lawnmower transmission will be driven fastest when the belt is positioned closest to its axis and slowest when the belt is positioned farthest from its axis. However, assuming uniform contact between the belt and the driven pulley, the smallest amount of torque will be transferred to the driven pulley when the belt is positioned closest to its axis and the largest amount of torque will be transferred to the driven pulley when the belt is positioned farthest from its axis.

Oftentimes, the belt is in a supposedly disengaged position when it is positioned farthest from the axis of the driven pulley. However, as discussed above, the largest amount of torque can be transferred to the driven pulley when the belt is positioned farthest from its axis. Torque transferred to the driven pulley when the belt is in the disengaged position is not required, and can be detrimental to the efficient operation of the transmission.

Consequently, there is a need to provide a transmission insuring that the amount of torque, if any, transferred to the driven pulley is minimized when the belt is in the disengaged position. Such a transmission can be configured, if necessary, to insure that the amount of torque transferred to the driven pulley is maximized when rotating at high speeds.

### SUMMARY

In general, the present invention contemplates a transmission including a housing and a gear assembly supported by the housing. The gear assembly includes a shaft carried by the housing, a bull gear attached to the shaft, and a helical gear shaft carried by the housing. The helical gear shaft incorporates a helical gear operatively connected to the bull gear. The transmission can be either a single-speed transmission or a variable-speed transmission.

### BRIEF DESCRIPTION OF THE DRAWINGS

FIG. 1 is a side plan view of a housing used in conjunction with the transmissions according to the present invention.

FIG. 2 is an exterior plan view of the first half of the housing.

FIG. 3 is an interior plan view of the first half of the housing.

FIG. 4 is an exterior plan view of the second half of the housing.

FIG. 5 is an interior plan view of the second half of the housing.

FIG. 6 is a cross-sectional view along Line 3-3 of FIG. 1 showing a gear assembly positioned in the first half of the housing.

FIG. 7 is a side plan view of a single-speed transmission employing the housing, the gear assembly, and a driven pulley, having a cutaway showing the gear assembly, and a cross-section of the driven pulley.

FIG. 7A is a side plan view of a single-speed transmission of FIG. 7 having a cutaway showing the use of a bushing and a bearing to support a helical gear shaft, and a cross-section of the driven pulley.

FIG. 8 is a side plan view of the single-speed transmission of FIG. 7 showing the single-speed transmission in a first position and a second position.

FIG. 9 is an enlarged cross-sectional view of a belt.

FIG. 10 is an enlarged cross-sectional view of FIG. 8 showing the engagement surfaces of the driven pulley.

FIG. 11A is a side plan view of a variable-speed transmission employing the housing, the gear assembly, and a separable driven pulley, having a cutaway showing the gear assembly, and a cross-section of the driven pulley with the second half of the driven pulley located in an upward position.

FIG. 11B is a side plan view of the variable-speed transmission of FIG. 11A having a cutaway showing the gear assembly, and a cross-section of the driven pulley with the second half of the driven pulley located in a downward position.

FIG. 11X is a partial side plan view of the variable-speed transmission of FIGS. 11A and 11B having a cutaway showing the use of a bushing and a bearing to support the helical gear shaft.

FIG. 12 is an enlarged cross-sectional view of FIG. 11A showing the compound surfaces of the driven pulley,

FIG. 13 is a schematic view of the variable speed transmission of FIGS. 11A and 11B showing a first position and a second position an idler bracket pivotably attached to the housing relative to a belt wrapped around the driven pulley, an idler pulley attached to the idler bracket, and a drive pulley.

### DETAILED DESCRIPTION

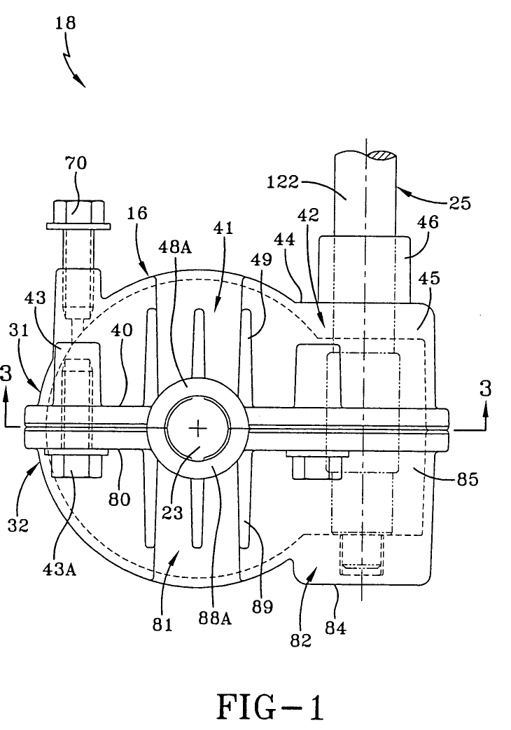

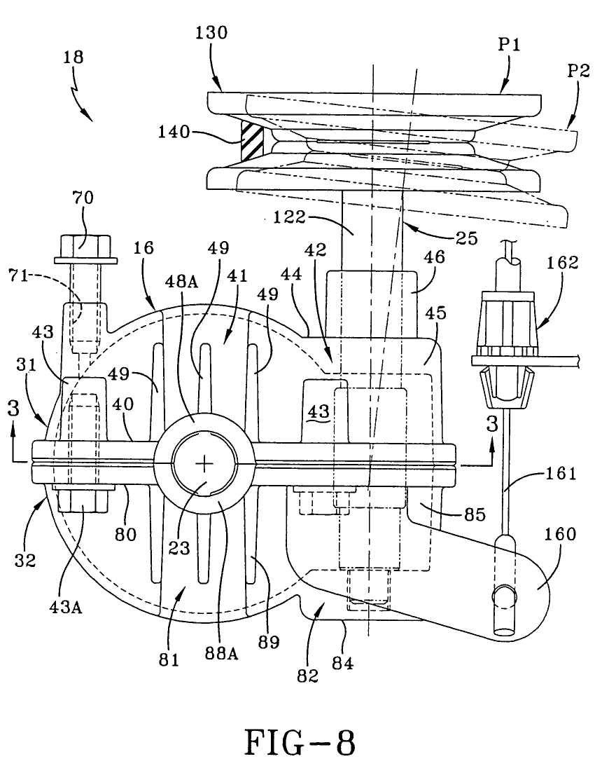

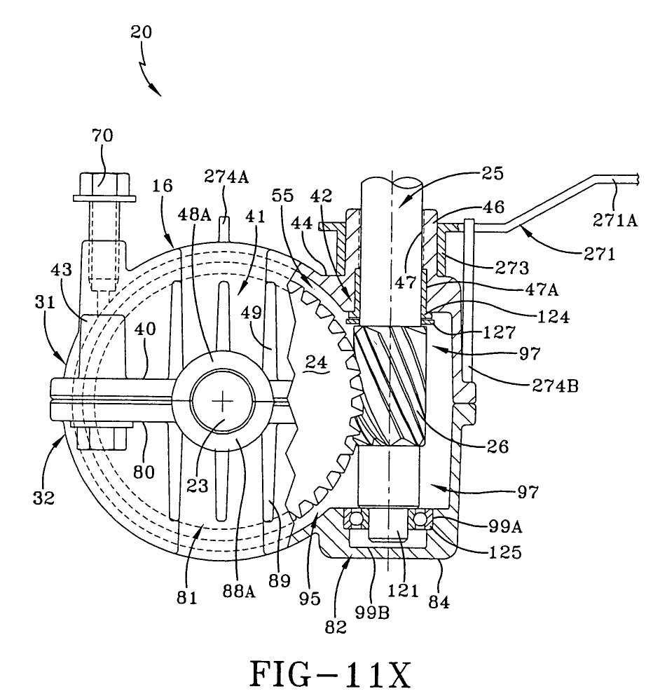

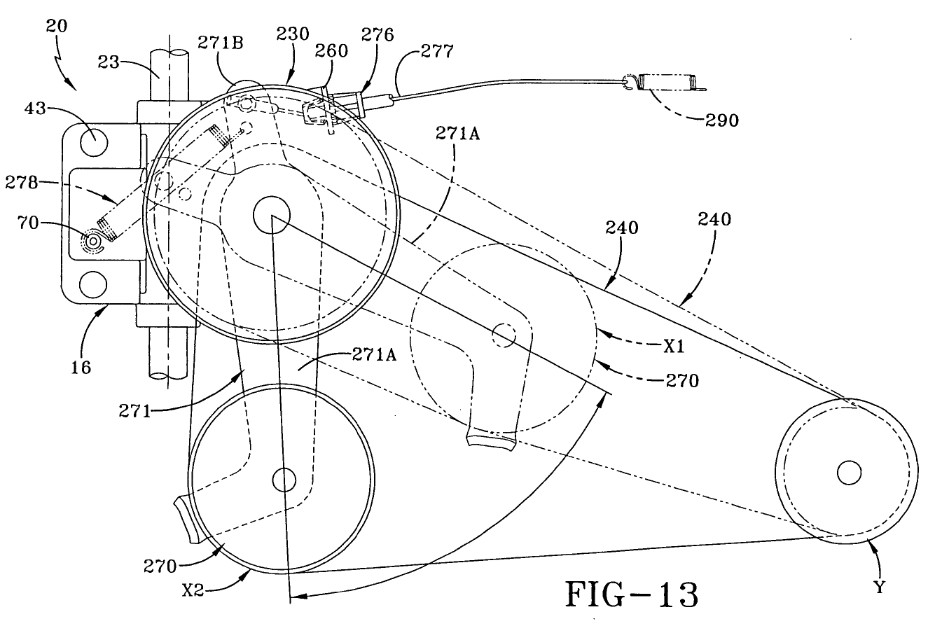

Referring to FIG. 1, a housing is generally indicated by the numeral 16. The housing 16 is used in conjunction with a single-speed transmission 18 depicted in FIGS. 7, 7A, 8, and 10, and with a variable-speed transmission 20 depicted in FIGS. 11A, 11B, 11X, and 13. As seen in FIGS. 7 and 7A for the single-speed transmission 18, and as seen in FIGS. 11A, 11B, and 11X for the variable-speed transmission 20, the housing 16 incorporates a gear assembly 21. Generally, the gear assembly 21 is supported by the housing 16, and includes a shaft 23 such as an axle, a bull gear 24 attached to the shaft 23, and a helical gear shaft 25 having a helical gear 26 formed thereon.

As discussed hereinbelow, the single-speed transmission 18 and variable-speed transmission 20 may be separately attached to lawnmowers (not shown). The single-speed transmission 18 and variable-speed transmissions 20 would then be used to translate rotational movement from a lawnmower engine (not shown) to the shaft 23. Although use with a lawnmower is exemplified for purposes of convenience with respect to this specification, the single-speed transmission 18 and variable-speed transmission 20 are capable of use with similar small engine driven apparatus having similar power transmission requirements as a lawnmower.

The rotation of shaft 23 drives operatively interconnected wheels (not shown) to move the lawnmower in a forward direction. More specifically, the single-speed transmission 18 and variable-speed transmission 20 are adapted to drive the front wheels of a lawnmower. However, as appreciated by those skilled in the art, the single-speed transmission 18 and variable-speed transmission 20 could both easily be re-configured to drive the rear wheels of a lawnmower.

With reference to FIG. 1, the housing 16 is divided into a first section 31 and a second section 32. When the housing 16 is assembled, the first section 31 is located above the second section 32. The first section 31 and second section 32 are composed of cast aluminum, and can be used in the variable-speed transmission 20 with limited machining, such as to remove flashing.

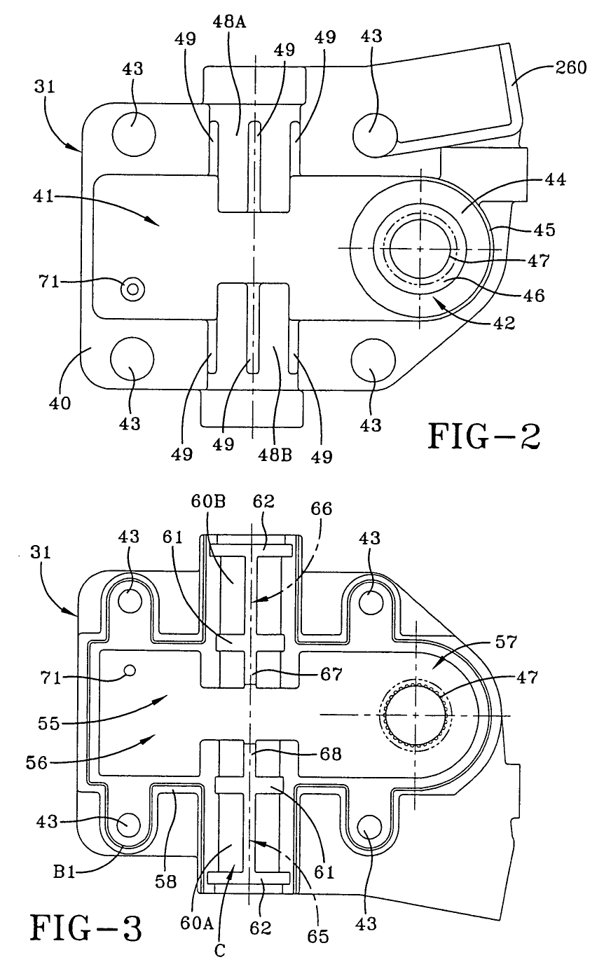

As seen in FIG. 2, the exterior of the first section 31 includes a first flat surface 40 extending around the perimeter of a first bull gear sub-housing 41 and a first helical gear shaft sub-housing 42. As discussed hereinbelow, the first bull gear sub-housing 41 and first helical gear shaft sub-housing 42, respectively, provide space on the interior of the first section 31 for accommodating portions of the bull gear 24 and helical gear shaft 25. As seen in FIG. 2, the first bull gear sub-housing 41 and first helical gear shaft sub-housing 42 together may have a “dumb-bell” shape.

Four apertured columns 43 are provided along the perimeter of the first section 31, and extend upwardly from the flat surface 40. The four apertured columns 43 each may have an aperture for receiving screws 43A used to join the first section 31 and second section 32 together.

The first bull gear sub-housing 41 and first helical gear shaft sub-housing 42 effectively extend upwardly from the first flat surface 40. Furthermore, the first bull gear sub-housing 41 is semi-cylindrical, and shares an axis with the shaft 23 and the bull gear 24. The first helical gear shaft sub-housing 42 includes a top surface 44, and a contoured surface 45 extending between the flat surface 40 and the top surface 44. An extension cylinder 46 extends upwardly from the top surface 44. A hole 47 is provided through the extension cylinder 46 and the first helical gear shaft sub-housing 42. When the housing 16 and gear assembly 21 are assembled, the helical gear shaft 25 extends out of the housing 16 through the hole 47.

In addition to the first bull gear sub-housing 41 and first helical gear shaft sub-housing 42, the first section 31 includes shaft sub-housings 48A and 48B which extend upwardly from the first flat surface 40. The shaft sub-housings 48A and 48B are semi-cylindrical, and share axes with the first bull gear sub-housing 41. As seen in FIG. 2, the shaft sub-housings 48A and 48B extend outwardly from the first bull gear sub-housing 41 in opposite directions. The shaft sub-housings 48A and 48B are used to form a portion of a cylindrical cavity C through which the shaft 23 extends in the housing 16. In addition, fins 49 which extend outwardly from the first bull gear sub-housing 41 may be provided along the surface of the shaft sub-housings 48A and 48B. The fins 49 are used to dissipate heat from the first section 31 of the housing 16.

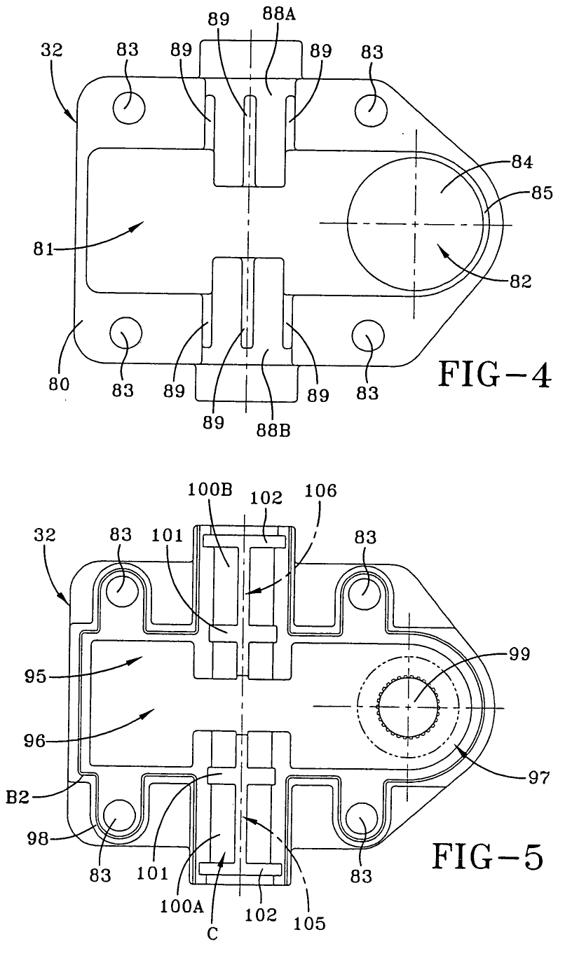

As seen in FIG. 3, the interior of the first section 31 includes a first interior cavity 55 formed by the first bull gear sub-housing 41 and first helical gear shaft sub-housing 42. The first interior cavity 55 is configured to receive portions of the bull gear 24 and helical gear shaft 25. For example, the first interior cavity 55 includes a first central portion 56 adapted to house a portion of the bull gear 24. Furthermore, the first interior cavity 55 also includes a first peripheral portion 57 configured accommodate a portion of the helical gear shaft 25. As such, the hole provided through the extension cylinder 46 and first helical gear sub-housing 42 communicates with the first peripheral portion 57.

A first interface surface 58 surrounds the perimeter of the first interior cavity 55, and the first section 31 and second section 32 are ultimately aligned along a plane parallel to the first interface surface 58. In certain embodiments, a first radiused bead B1 traces the first interface surface 58 around the first interior cavity 55. As discussed hereinbelow, the first radiused bead B1 is used in providing a seal between the first section 31 and second half without the need for additional seals.

A portion of the hole 47 provided through the first extension cylinder 46 and first helical gear shaft sub-housing 42 may be provided with serrated edges. As seen in FIG. 3, the serrated edges are formed along the circumference of the hole 47. Using a punching process, the serrated edges may be “coined,” and therefore, sized to fit the circumference of the helical gear shaft 25. That is, during the punching process, portions of the material forming the serrated edges are forced into the spaces therebetween, and the remaining area of the hole 47 is sized to accommodate the helical gear shaft 25. Therefore, limited or possibly no machining is required to adapt the serrated edges to allow the helical gear shaft 25 to be properly positioned within the hole 47.

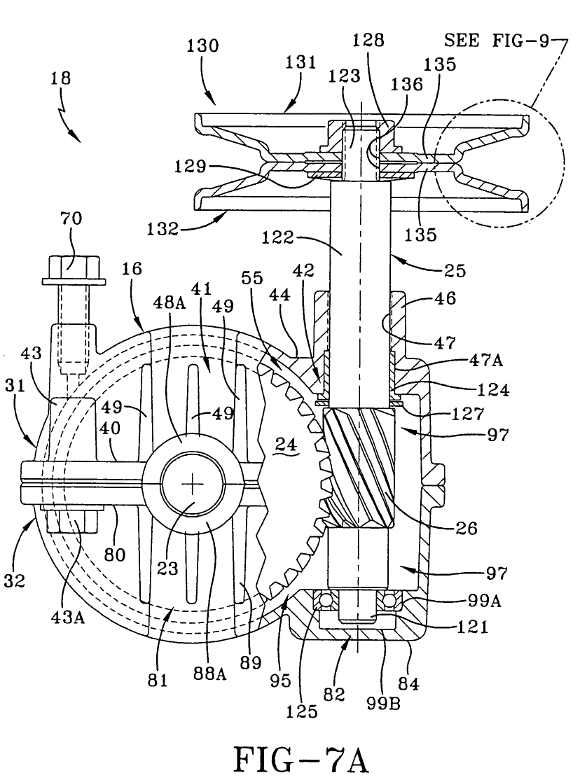

As discussed above, the cylindrical cavity C extends through the housing 16 to accommodate the shaft 23. The cylindrical C is partially formed on either side of the first central portion 56 from the area provided by the shaft sub-housings 48A and 48B. As seen in FIG. 3, semi-cylindrical surfaces 60A and 60B are formed on the under surface of the shaft sub-housings 48A and 48B, respectively. When the housing 16 and gear assembly 21 are assembled, the shaft 23 extends through the cylindrical cavity C, and is supported on the first section 31 by the semi-cylindrical surfaces 60A and 60B. Grease capturing grooves generally indicated by the numerals 65 and 66 are provided in the semi-cylindrical surfaces 60A and 60B, respectively. The lubricant capturing grooves 65 and 66 include inner segments 61, outer segments 62, and channels 67 and 68 extending therebetween in the semi-cylindrical surfaces 60A and 60B, respectively. The lubricant capturing grooves 65 and 66 capture grease (or other lubricant) to insure that the shaft 23 is lubricated as it rotates within the cylindrical cavity C, and the channels 67 and 68 communicate with the first interior cavity 55 to provide such grease. If necessary, the outer segments 62 are adapted to receive seal rings 69 (FIG. 6), which prevent grease from escaping the housing 16.

A grease screw 70 and threaded hole 71 for receiving the grease screw 70 are provided on the exterior surface of the first bull gear sub-housing 41. The removal of the grease screw 70 from the threaded hole 71 allows access to the interior of the housing 16. Such access allows a user to inject grease into the interior of the housing 16. Furthermore, the threaded hole 71 could be provided with a channel along its axial length. The channel would allow air to escape the interior of the housing 16 even when the grease screw 70 is positioned within the threaded hole 71.

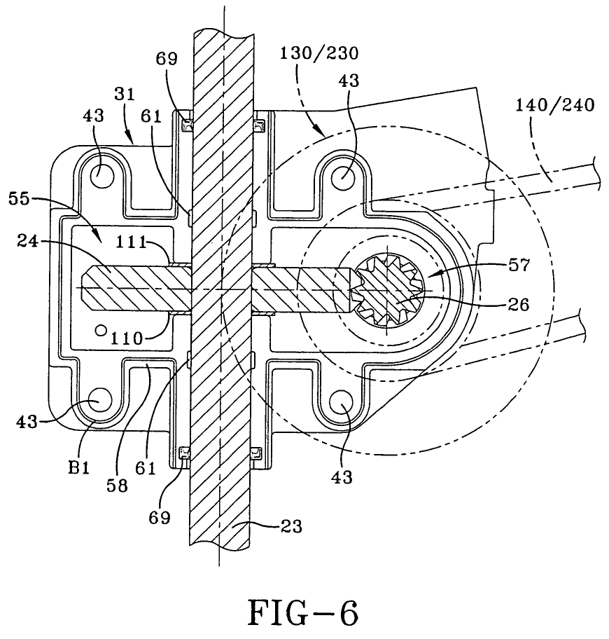

As seen in FIG. 4, the exterior of the second section 32 includes a second flat surface 80 extending around the perimeter of a second bull gear sub-housing 81 and a second helical gear shaft sub-housing 82. As discussed hereinbelow, the second bull gear sub-housing 81 and second helical gear shaft sub-housing 82, respectively, provide space on the interior of the second section 32 for accommodating portions of the bull gear 24 and helical gear shaft 25. As seen in FIG. 4, the second bull gear sub-housing 81 and second helical gear shaft sub-housing 82 together may have a “dumb-bell” shape.

Four apertures 83 may be provided along the perimeter of the first section 31. The four apertures 83 cooperate with the above-referenced apertured columns 43, and receive the screws 43A used to join the first section 31 and second section 32 together.

The second bull gear sub-housing 81 and second helical gear sub-housing 82 effectively extend upwardly from the second flat surface 80. Furthermore, the second bull gear sub-housing 81 is semi-cylindrical, and shares an axis with the shaft 23 and the bull gear 24. The second helical gear shaft sub-housing 82 includes a top surface 84, and a contoured surface 85 extending between the flat surface 80 and the top surface 84.

In addition to the second bull gear sub-housing 81 and second helical gear shaft sub-housing 82, the second section 32 includes shaft sub-housings 88A and 88B which extend upwardly from the second flat surface 80. The shaft-sub-housings 88A and 88B are semi-cylindrical, and share axes with the second bull-gear sub-housing 81. As seen in FIG. 4, the shaft sub-housings 88A and 88B extend outwardly from the second bull gear sub-housing 81 in opposite directions. The shaft sub-housings 88A and 88B are used to form a portion of the cylindrical cavity C through which the shaft 23 extends in the housing 16. Furthermore, fins 89 may be provided along the surface of the shaft sub-housings 88A and 88B, and extend outwardly from the second bull-gear sub-housing 81. The fins 89 are used to dissipate heat from the second section 32 of the housing 16.

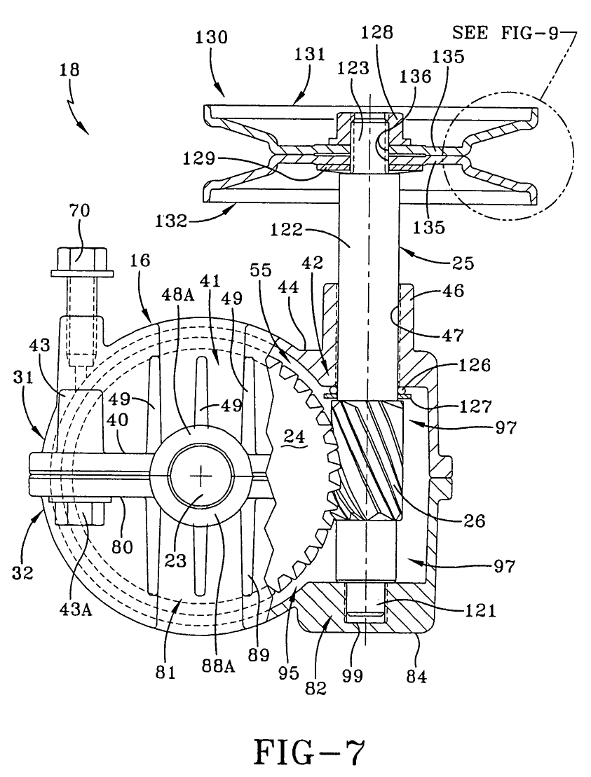

As seen in FIG. 5, the interior of the second section 32 includes a second interior cavity 95 formed by the second bull gear sub-housing 81 and second helical gear shaft sub-housing 82. The second interior cavity 95 is configured to receive portions of the bull gear 24 and helical gear shaft 25. For example, the second interior cavity 95 includes a second central portion 96 adapted to house a portion of the bull gear 24. Furthermore, the second interior cavity 95 also includes a second peripheral portion 97 configured to accommodate a portion of the helical gear shaft 25.

A second interface surface 98 surrounds the perimeter of the interior cavity 95, and the first section 31 and second section 32 are ultimately aligned along a plane parallel to the first interface surface 58 and second interface surface 98. Also, in certain embodiments, a second radiused bead B2 traces the second interface surface 98 around the second interior cavity 95. The second radiused bead B2 is used in providing a seal between the first section 31 and second section 32. For example, when the first section 31 and second section 32 are assembled, the first radiused bead B1 and second radiused bead B2 interface with one another. The radiused beads B1 and B2 have upwardly facing curved surfaces, and the radiused beads B1 and B2 interface along these curved surfaces. The interface of the curved surfaces of the radiused beads B1 and B2 provides for the sealing of the housing 16 without the need for additional seals.

A receiver 99 adapted to receive a portion of the helical gear shaft 25 is provided in the second peripheral portion 97. Like the hole 47 provided through the extension cylinder 46 and first helical gear shaft sub-housing 42, serrated edges are formed along the circumference of the receiver 99. Limited or possibly no machining is required to use the second section 32 because the serrated edges may be “coined” using a punching process. That is, during the punching process, portions of the material forming the serrated edges are forced into the spaces therebetween, and the remaining area of the receiver 99 is sized to accommodate the helical gear shaft 25. As such, little machining is required to adapt the serrated edges to allow the helical gear shaft 25 to be positioned properly in the receiver 99.

As discussed above, the cylindrical cavity C extends through the housing 16 to accommodate the shaft 23. The cylindrical C is partially formed on either side of the first central portion 56 from the area provided by the shaft sub-housings 48A and 48B. As seen in FIG. 3, semi-cylindrical surfaces 60A and 60B are formed on the under surface of the shaft sub-housings 48A and 48B, respectively. When the housing 16 and gear assembly 21 are assembled, the shaft 23 extends through the cylindrical cavity C, and is supported on the first section 31 by the semi-cylindrical surfaces 60A and 60B. Grease capturing grooves generally indicated by the numerals 65 and 66 are provided in the semi-cylindrical surfaces 60A and 60B, respectively. The lubricant capturing grooves 65 and 66 include inner segments 61, outer segments 62, and channels 67 and 68 extending therebetween in the semi-cylindrical surfaces 60A and 60B, respectively. The lubricant capturing grooves 65 and 66 capture grease (or other lubricant) to insure that the shaft 23 is lubricated as it rotates within the cylindrical cavity C, and the channels 67 and 68 communicate with the first interior cavity 55 to provide such grease. If necessary, the outer segments 62 are adapted to receive seal rings 69 (FIG. 6), which prevent grease from escaping the housing 16.

As discussed above, the cylindrical cavity C extends through the housing 16 to accommodate the shaft 23. In addition to the areas provided by the shaft sub-housings 48A and 48B, the remainder of the cylindrical cavity C is formed on either side of the first central portion 96 from the area provided by the shaft sub-housings 88A and 88B. As seen in FIG. 5, semi-cylindrical surfaces 100A and 100B are formed on the under surface of the shaft sub-housings 88A and 88B, respectively. Ultimately, the shaft 23 extends through the cylindrical cavity C, and is supported on the first section 31 by the semi-cylindrical surfaces 60A and 60B and on the second section 32 by the semi-cylindrical surfaces 100A and 100B. Like the lubricant capturing grooves 65 and 66 provided in the semi-cylindrical surfaces 60A and 60B, respectively, lubricant capturing grooves 105 and 106 are provided in the semi-cylindrical surfaces 100A and 100B, respectively. The lubricant capturing grooves 105 and 106 include inner segments 101 and outer segments 102, and channels 107 and 108 extending therebetween in the semi-cylindrical surfaces 100A and 100B, respectively. The lubricant capturing grooves 105 and 106, like the lubricant capturing grooves 95 and 96, capture great (or other lubricant) to insure that the shaft 23 is lubricated as it rotates within the cylindrical cavity C, and the channel 107 and 108 communicate with the second interior cavity 95 to provide such grease. The outer segments 102, like the outer segments 62, can be adapted to receive seal rings 69 (FIG. 6), which prevent grease from escaping the housing 16.

When the housing 16 and gear assembly 21 are assembled, the shaft 23 is supported in the cylindrical channel C by the semi-cylindrical surfaces 60A and 60B of the first section 31 and by the semi-cylindrical surfaces 100A and 100B of the second section 32. Furthermore, via the abutment of inner segments 61 and 101 and the abutment of the outer segments 62 and 102 (when the housing and gear assembly 21 are assembled), the lubricant capturing grooves 65 and 105 communicate with one another, and the lubricant capturing grooves 96 and 106 communicate with one another. As such, the lubricant capturing grooves 65 and 66 and the lubricant capturing grooves 105 and 106 serves to lubricant the shaft 23 such that additional bearings and/or bushings are optional.

In addition, when the housing 16 and gear assembly 21 are assembled, the shaft 23 is provided with thrust washers 110 and 111 on either side of the bull gear 24. The thrust washers 110 and 111 maintain the positioning of the shaft 23 such that the bull gear 24 remains in the first central portion 56 and second central portion 96. As such, the bull gear 24 is supported in a saddle-like configuration within the first central portion 56 and second central portion 96 which prevents significant axial movement of the shaft 23 and bull gear 24 relative to the housing 16.

As seen in FIGS. 6, 7, 11A and 11B, the bull gear 24 interfaces with the helical gear 26. The helical gear shaft 25 and helical gear 26 can be formed of powdered metal. In fact, the helical gear 26 may be formed on the helical gear shaft 25 using a process described in U.S. Pat. No. 5,659,955, and that U.S. Patent is incorporated herein by reference.

Unlike using a worm gear, the use of the helical gear 26 allows the bull gear 24 and helical gear 26 to rotate in either direction. That is, even though the helical gear 26 is normally operatively connected to the bull gear 24 to transfer its rotational movement thereto, and drive the front wheels operatively interconnected with the shaft 23 in a forward direction, the user can forceably drive the front wheels in a reverse direction. When the front wheels attached to the shaft 23 are driven in the reverse direction, the bull gear 24 and helical gear 26 are adapted rotate in a direction opposite to their normal direction of rotation, without either the single-speed transmission 18 or variable-speed transmission 20 “locking up.” Therefore, a user can pull the lawnmower in the reverse direction without needing to lift the front wheels off of the ground.

As discussed hereinabove, the helical gear 26 is provided on the helical gear shaft 25, and like the shaft 23 and bull gear 24, is supported by the housing 16. The helical gear shaft 25 can be adapted to function with both the single-speed transmission 18 and the variable-speed transmission 20. As such, the helical gear shaft 25 can be adapted to function with components forming the single-speed transmission 18 and the variable-speed transmission 20.

The helical gear shaft 25 is segmented into various portions including a first segment 121, a second segment 122, and a third segment 123. The first segment 121 has a diameter sized to fit within the receiver 99 formed in the second section 32. The second segment 122 includes the helical gear 26 and extends between the first segment 121 and third segment 123. The diameter of the helical gear 26 is larger than the diameter of the remainder of the second segment 122. As such, on the interior of the housing 16, the second segment 122 is provided with a ring seal 126 and washer 127, which, because the ring seal 126 and washer 127 have diameters larger than the diameter of the hole 47, effectively “clamp” the helical gear shaft 25 in position relative to the housing 16. That is, when the housing 16 and gear assembly 21 are assembled, the ring seal 126 and washer 127 abut the helical gear 26 and abut the first helical gear shaft sub-housing 42 surrounding the hole 47 to prevent axial movement of the helical gear shaft 25.

If necessary, the hole 47 can be provided with a bushing 124, as seen in FIGS. 7A and 11X. The bushing 124 would reduce the amount of friction generated through rotation of the second segment 122 as it passes through the hole 47. For example, the hole 47 could include a segment 47A to accept the bushing 124. The segment 47A could be serrated, and, thereafter sized through a punching process to accommodate the bushing 124. As such, limited or possibly no machining would be required to adapt the serrated edges to allow the bushing 124 to be properly positioned within the hole 47.

Additionally, the receiver 99 could be sized to accept a bearing 125 to reduce the amount of friction generated by through the rotation of the first segment 121. For example, as seen in FIGS. 7A and 11X, the receiver 99 could be configured to have a first receiver section 99A and a second receiver section 99B. The first receiver section 99A would be configured to receive the bearing 125, and the second receiver section 99B would provide additional space for accommodating the first segment 121. Furthermore, the first receiver section 99A could be serrated, and, thereafter sized through a punching process to accommodate the bearing 125. As such, limited or possibly no machining would be required to adapt the serrated edges to allow the bearing 125 to be properly positioned within the first receiver section 99A.

Ultimately, the third segment 123 of the helical gear shaft 25 extends outwardly from the second segment 122 (on the exterior of the housing 16), and can be alternately sized to accommodate components forming the single-speed transmission 18 and variable-speed transmission 20. For example, when the housing 16 and gear assembly 21 are used in forming the single-speed transmission 18, the third segment 123 is relatively short. However, when the housing 16 and gear assembly 21 are used in forming the variable-speed transmission 20, the third segment 123 is relatively long. Either way, the third segment 123 is threaded for accommodating a nut 128 used to attach components for the single-speed transmission 18 and variable-speed transmission 20 to the helical gear shaft 25.

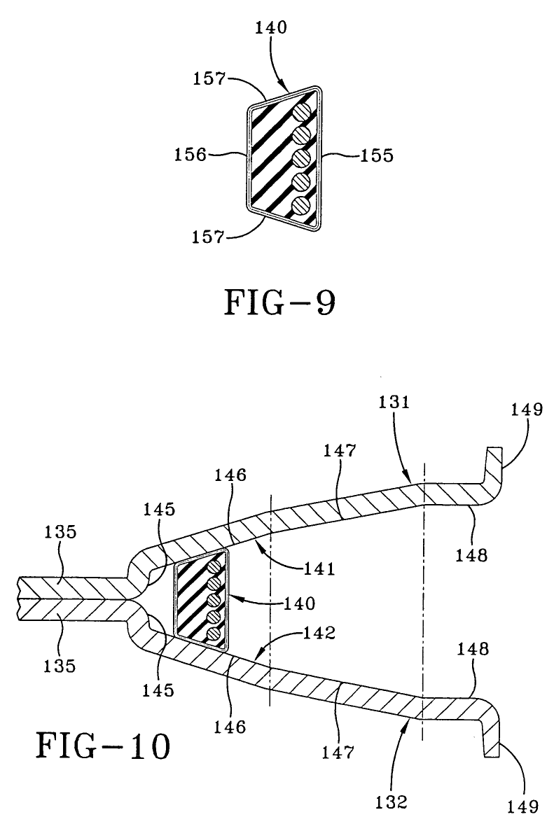

The single-speed transmission 18, as seen in FIGS. 7, 7A, and 8, includes a driven pulley 130 having a first half 131 and a second half 132. The first and second pulley halves 131 and 132 include disk portions 135, and apertures 136 provided through the disk portions 135. The apertures 136 are sized to receive the third segment 123 of the helical gear shaft 24. As such, a washer 129 is used in conjunction with the nut 128 to fasten the pulley 130 to the helical gear shaft 25.

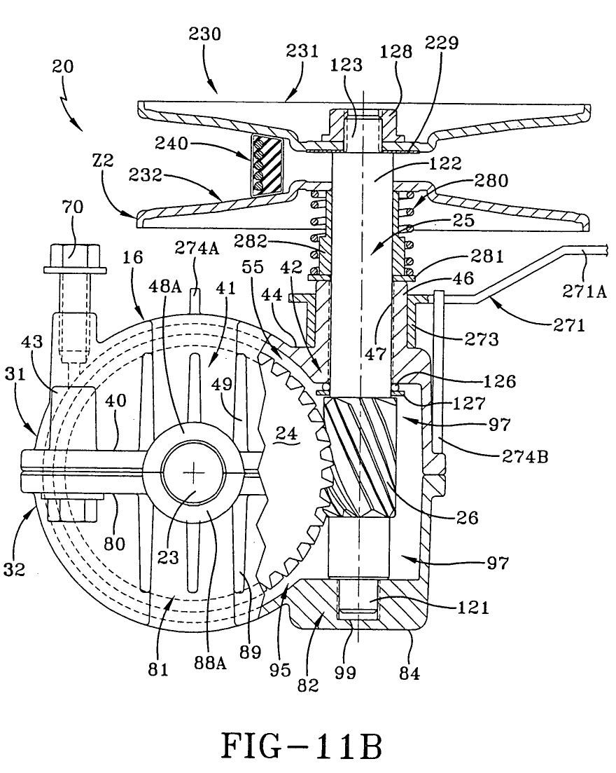

The pulley 130 includes engagement surfaces 141 and 142 provided on the first and second pulley halves 131 and 132, respectively. As seen in FIG. 10, the engagement surfaces 141 and 142 extend outwardly from transition surfaces 145 connected with the disk portions 135. The engagement surfaces 141 and 142 are each formed from at least one frusto-conical surface extending outwardly from the transition surfaces 145, and ring-shaped surfaces 148. For example, the engagement surfaces 141 and 142 can be formed from first and second frusto-conical surfaces 146 and 147 (FIG. 10) extending outwardly from transition surfaces 145 to the ring-shaped surfaces 148. Furthermore, rims 149 extend outwardly from the ring-shaped surfaces 148 to reinforce the first and second pulley halves 131 and 132.

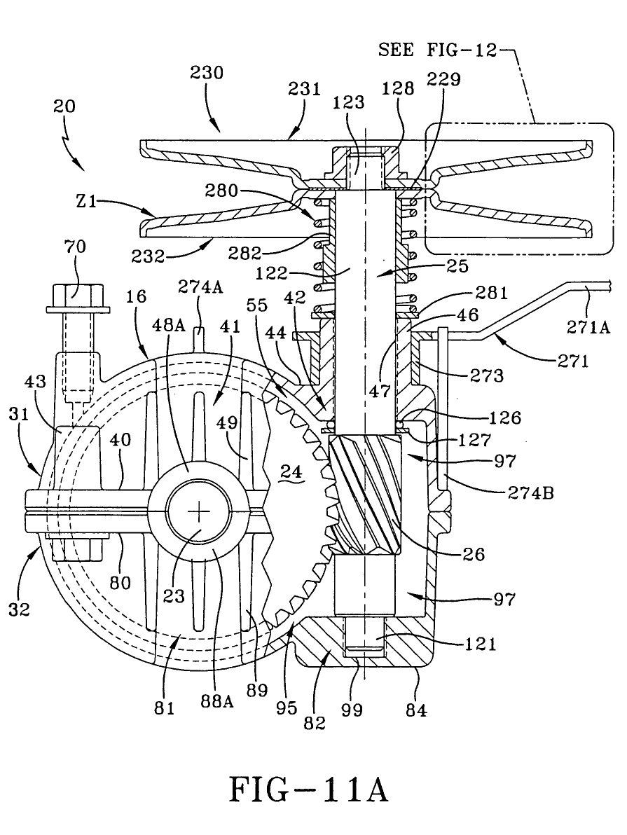

A belt 140 is wound around the pulley 130 and a drive pulley (not shown) attached to the lawnmower engine. As seen in FIG. 9, the belt 140 has a trapezoidal cross-section defined by first and second parallel surfaces 155 and 156, where the first parallel surface 155 is longer than the second parallel surface 156. Extending between the first and second parallel surfaces are inclined surfaces 157.

The inclination of the single-speed transmission 18 determines the radial position of the belt 140 around the pulley 130, and hence, the amount of contact between the inclined surfaces 157 of the belt 140 and the engagement surfaces 141 and 142 of the pulley 130. For example, as seen in FIG. 8, the single-speed transmission 18 is capable of pivotal movement on the shaft 23 between an engaged first position P1 and a disengaged second position P2. In the engaged first position P1, the interaction of the belt 140 with the engagement surfaces 141 and 142 insures that the amount of torque is transferred to the pulley 130 is maximized at that position, and in the disengaged second position P2, the interaction (or lack thereof) of the belt 140 with the engagement surfaces 141 and 142 insures that the amount of torque is transferred to the pulley 130 is minimized at that position.

As discussed above, the pivotal movement of the single-speed transmission 18 determines the radial position of the belt 140 around the pulley 130. For example, when the single-speed transmission 18 is in the engaged first position P1, the belt 140 is in the closest-permitted position relative to the axis of the pulley 130 adjacent the first frusto-conical surfaces 146. Furthermore, when the single-speed transmission 18 is in the disengaged second position P2, the belt 140 is in the farthest-permitted position relative to the axis of the pulley 130 adjacent the ring-shaped surfaces 148.

The inclined surfaces 157 are configured to interact with the engagement surfaces 141 and 142 to insure that the amount of torque transferred to the pulley 130 in the engaged first position P1 is maximized and that the amount of torque transferred to the pulley 130 in the disengaged second position P2 is minimized. For example, when the single-speed transmission 18 is in the engaged first position P1, the inclined surfaces 157 are in substantial contact with the first frusto-conical surfaces 146. The substantial contact between the belt 140 and the engagement surfaces 141 and 142 in the engaged first position P1 insures that torque is efficiently delivered to the pulley 130.

However, when the single-speed transmission 18 is in the disengaged second position P2, the inclined surfaces 157 have only limited contact with the ring-shaped surfaces 148, and only a small amount of torque, if any, is delivered to the pulley 130. When the single-speed transmission 18 is in the disengaged second position P2, there is an inherent “clutching effect” because the belt 140 slips on the pulley 130 due to the limited contact between the inclined surfaces 157 and the ring-shaped surfaces 148. The lack of contact between the inclined surfaces 157 and the ring-shaped surfaces 148 in the disengaged second position P2 serves to effectively disengage the belt 140 from the pulley 130 to prevent rotation of the helical gear shaft 25.

A user is capable of engaging and disengaging operation of the single-speed transmission 18 using a user operated cable assembly 162. For example, a spring (not shown) is attached to the housing 16. The spring extends along one side of the single-speed transmission 18, and is fixedly attached to the lawnmower. The spring biases the single-speed transmission 18 to the disengaged second position P2. In addition, the single-speed transmission 18 is provided with a pivot bracket 160 (FIG. 8) extending along one side of the single-speed transmission 18. A cable 161 attached to the pivot bracket 160 extends from the user operated cable assembly 162. When the user operated cable assembly 162 is activated by the user (on, for example, the lawnmower's handle), the cable 161 pulls the pivot bracket 160 upwardly to overcome the force of the spring. In doing so, the cable 161 pivots the single-speed transmission from the disengaged second position P2 to the engaged first position P1. Furthermore, when the user operated cable assembly 162 is deactivated by the user, the spring returns the single-speed transmission 18 to the disengaged second position P2. As such, the user is capable pivotably moving the single-speed transmission 18 to actuate it between the engaged first position P1 and disengaged second position P2.

The variable-speed transmission 20, as seen in FIGS. 11A, 11B, 11X, and 13, includes a separable driven pulley 230 having a first half 231 and a second half 232. The first and second halves 231 and 232 are separable from one another, and include disk portions 235. The disk portion 235 of the first half 231 includes a small aperture 236 and the disk portion 235 of the second half 232 includes a large aperture 237. The small aperture 236 is sized to receive the third segment 123. As such, a washer 229 is used in conjunction with the nut 128 to fasten the first half 231 to the helical gear shaft 25. Furthermore, the large aperture 237 is sized to receive a portion of the second segment 122. As discussed below, the second half 232 is capable of axial movement between an upward position and a downward position along the second segment 122.

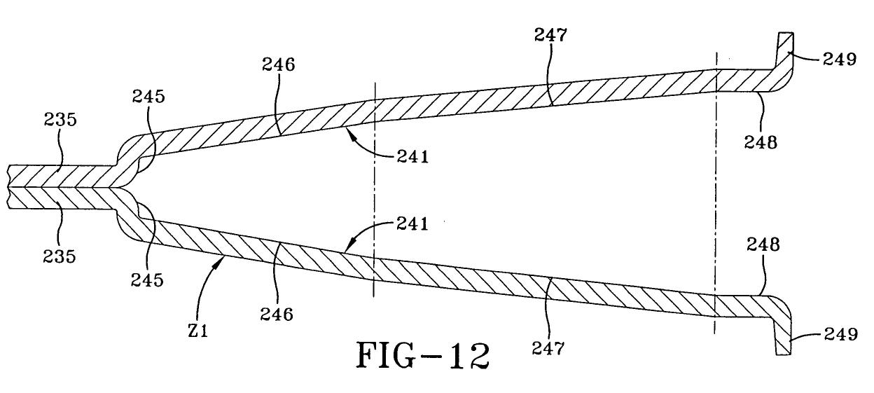

The driven pulley 230 includes compound engagement surfaces 241 and 242 provided on the first and second pulley halves 231 and 232, respectively. The compound engagement surfaces 241 and 242 extend outwardly from transition surfaces 245 attached to the disk portions 235. The compound engagement surfaces 241 and 242 are each formed from at least one frusto-conical surface extending outwardly from the transition surfaces 245, and ring-shaped surfaces 248. For example, the compound engagement surfaces 241 and 242 include first and second frusto-conical surfaces 246 and 247 (FIG. 12), and the ring-shaped surfaces 248 extend outwardly from the second frusto-conical surfaces 247. Rims 249, which reinforce the first and second pulley halves 231 and 232, extend outwardly from the ring-shaped surface 248.

As seen in FIG. 13, a belt 240 is wound around the driven pulley 230, an idler pulley 270, and a drive pulley Y attached to the lawnmower engine. The belt 240, like the belt 140 depicted in FIG. 9, has a trapezoidal shape defined by first and second parallel surfaces 155 and 156, and inclined surfaces 157.

The idler pulley 270 is pivotably connected to the housing 16 by an idler bracket 271 having a first arm 271A and a second arm 271B. The idler bracket 271 includes a cylindrical aperture 272 formed through a cylindrical shoulder 273 (FIGS. 11A, 11B, and 11X) used to raise the position of the idler bracket 271 relative to the driven pulley 230. The cylindrical shoulder 273 is provided adjacent the intersection of the first and second arms 271A and 271B, and the cylindrical aperture 272 is adapted to receive the extension cylinder 46 to allow the idler bracket 271 (and idler pulley 270 attached thereto) to pivot relative the driven pulley 230.

As seen in FIG. 13, the idler pulley 270 is pivotably moveable with the first arm 271A between a first position X1 and a second position X2, and, as discussed below, the position of the idler pulley 270 determines the radial position of the belt 240 around the driven pulley 230. The pivotal movement of the idler bracket 271 is limited between the first position X1 and second position X2. For example, as seen in FIGS. 11A, 11B, and 11X, a stop 274A is provided to stop the pivotal movement of the idler bracket 271 at the first position X1, and a stop 274B is provided to stop the pivotal movement of the idler bracket 271 at the second position X2. The stop 274A (which can be integrally cast with the first section 31) extends outwardly from the first bull gear sub-housing 41 to interact with the second arm 271B. Furthermore, the stop 274B (which can also be integrally cast with the first section 31) extends outwardly from the first flat surface 40 adjacent the first helical gear shaft sub-housing 42 to interact with the first arm 271A.

A user operated cable assembly 276 is provided to allow a user to reposition the idler bracket 271 (and idler pulley 270 attached thereto) between the first position X1 and second position X2. As discussed below, the repositioning of the idler pulley 270 effects the rotational speed of and the amount of torque transferred to the driven pulley 230 (and helical gear shaft 25) from the lawnmower engine. The user operated cable assembly 276 is attached to an apertured L-shaped bracket 260 that can be integrally formed with the first section 31 of the housing 16 (FIG. 2). A cable 277 from the user operated cable assembly 276 extending through the aperture (not shown) of the apertured L-shaped bracket 260 is attached to the second arm 2711B.

When the user operated cable assembly 276 is actuated by the user (on, for example, the lawnmower's handle), the cable 277 pulls the idler bracket 271 away from the first position X1. Depending on the force applied to the user operated cable assembly 276, the cable 277 can overcome the force of a spring 278 attached to the second arm 271B, and to the housing 16 by the grease screw 70. The spring 278 biases the idler bracket 271 into the first position X1, but, when enough force is applied through the cable 277, the idler bracket 271 can be repositioned from the first position X1 to the second position X2, and therebetween.

The position of the idler pulley 270 (at or between the first position X1 and second position X2) effects the radial position of the belt 240 around the driven pulley 230, which, as discussed below, repositions the second pulley half 232 relative to the helical gear shaft 25. The second pulley half 232 is moveable in an axial direction along the second segment 122 between an upward position Z1 (FIG. 11A) and a downward position Z2 (FIG. 11B). A spring 280 is provided to bias the second pulley half 232 in the upward position Z1 abutting the first pulley half 231. The spring 280 is provided on the second segment 122 (of the helical gear shaft 25) between the second pulley half 232 and a washer 281 provided adjacent the extension cylinder 46. Furthermore, a stop 282, which prevents axial movement of the second half 232 past the downward position Z2, is also provided on the second segment 122 between the second pulley half 232 and the washer 281.

As the idler pulley 270 moves from the first position X1 to the second position X2, the belt 240 imparts greater radial forces against the compound engagement surfaces 241 and 242 of the first and second pulley halves 231 and 232, respectively. Due to the interface between the inclined surfaces 157 (of the belt 240) and the compound engagement surfaces 241 and 242, the radial forces imparted by the belt 240 are translated into an axial force. When the axial force generated by the radial force imparted by the belt 240 is sufficient, the force of spring 280 can be overcome to move the second pulley half 232 from the upward position Z1 toward position Z2. For example, when the idler pulley 270 is in the first position X1, the second pulley half 232 resides in the upward position Z1 because the radial force is not great enough to generate an axial force capable of overcoming the force of the spring 280. However, when the idler pulley 270 is in the second position X2, the second pulley half 232 resides in the downward position Z2 because the radial force is great enough to generate an axial force capable of overcoming the force of the spring 280.

Additionally, as the second pulley half 232 transitions between the upward position X1 and downward position X2 due to the repositioning of the idler bracket 271 (and idler pulley 270), the radial position of the belt 240 around the driven pulley 230 is effected. The radial position of the belt 240 around the driven pulley 230 effects the rotational speed and amount of torque transferred from the lawnmower engine to the gear assembly 21. For example, when the idler pulley 270 is in the first position X1 and the second pulley half 232 is in the upward position Z1, the belt 240 is in the farthest-permitted position relative to the axis of the driven pulley 230. Furthermore, when the idler pulley 270 is in the second position X2 and the second pulley half 232 is in the downward position Z2, the belt 240 is in the closest-permitted position relative to the axis of the driven pulley 230.

Assuming that the drive pulley Y has a constant speed and that there is uniform contact between the belt 240 and the driven pulley 230, a progressively larger amount of torque will normally be transferred to the driven pulley 230 as the belt 240 moves from the closest permitted position (i.e. radial position) relative to the axis of the driven pulley 230 (where the second pulley half 232 is in the downward position Z2) to the farthest-permitted position (i.e. radial position) relative to the axis of the driven pulley 230. However, the amount of torque transferred to the driven pulley 230 through the belt 240 is effected by the trapezoidal cross-sectional shape of the belt 240, and the shape of the compound engagement surfaces 241 and 242.

The variable-speed transmission 20 is configured such that the amount of torque transferred is maximized when the belt 240 is in the closest-permitted position to the axis of the pulley 230, is minimized when the belt 240 is in the farthest-permitted position to the axis of the pulley 230, and that there is an efficient transfer of torque therebetween. In fact, the compound engagement surfaces 241 and 242 are specially configured to interact with the cross-sectional shape of the belt 240 to insure provide for the efficient transfer of torque. For example, the first frusto-conical surfaces 246 are configured such that the belt 240 has substantial contact with the first frusto-conical surfaces 246 along the various possible radial positions (as the belt 240 moves outwardly). The second frusto-conical surfaces 247 are configured such that the belt 240 is in contact, but not substantial contact, with the second frusto-conical surfaces 247 along the various radial positions (as the belt 240 moves outwardly). Furthermore, the ring-shaped surfaces 248 are configured such that the belt 240 has only limited contact with the ring-shaped surfaces 248 along the various possible radial positions (as the belt moves outwardly). As such, due to the amount of contact the belt 240 has with the first frusto-conical surfaces 246, second frusto-conical surfaces 247, and ring-shaped surfaces 248, the amount of torque transferred from the belt 240 to the driven pulley 230 gets progressively smaller when the belt moves outwardly between the first frusto-conical surfaces 246, second frusto-conical surfaces 247, and ring-shaped surfaces 248.

However, the amount of torque transferred to the driven pulley 230 from the belt 240 actually increases as the belt 240 moves outwardly along each the first frusto-conical surfaces 246 and second frusto-conical surfaces 247. For example, substantial contact between the belt 240 and the first frusto-conical surfaces 246 is maintained as the belt 240 moves radially outwardly therealong. As such, the amount of torque transferred to the driven pulley 230 increases as the radial position of the belt 240 along the first-frusto conical surfaces 246 increases. Furthermore, contact, but not substantial contact between the belt 240 and the second frusto-conical surfaces 247 is maintained as the belt moves radially outwardly therealong. As such, the amount of torque transferred to the driven pulley increase as the radial position of the belt 240 along the second frusto-conical surfaces 247 increases.

Therefore, when the second pulley half 232 is at or near the downward position Z2, and the belt 240 is positioned along the first frusto-conical surfaces 246, the inclined surfaces 157 are in substantial contact with the first frusto-conical surfaces 246, and the amount of torque transferred from the belt 240 to the driven pulley 230 is maximized. Furthermore, when the second pulley half 232 is about halfway between the first position Z1 and second position Z2, and the belt is in position along the second frusto-conical surfaces 247, the inclined surface 147 are in contact, but not substantial contact, with the second frusto-conical surfaces 247, and the amount torque transferred from the belt 240 to the driven pulley 230 is neither maximized nor minimized. When the second pulley half 232 is at or near the upward position Z1, and the belt 240 is position along the ring-shaped surfaces 248, the inclined surfaces 157 have only limited contact with the ring-shaped surfaces 248, and the amount of torque transferred from the belt 240 to the driven pulley 230 is minimized.

In fact, when the second pulley half 232 is in the first position Z1, there is an inherent “clutching effect.” That is, because of the limited contact between the inclined surfaces 157 and the ring-shaped surfaces 248, the belt 240 is permitted to slip on the driven pulley 230. Such slippage effectively disengages the belt 240 from the driven pulley 230. As such, when the second pulley half 232 is in upward position Z1, the driven pulley 230 (and, hence, the helical gear shaft 25) will have a relatively small amount of torque, if any, transferred thereto. Therefore, unlike when the belt 240 is positioned along the first and second frusto-conical surfaces 246 and 247, the driven pulley 230 likely will not be rotating when the belt 240 is positioned along the ring-shaped surfaces 248.

Consequently, the amount of torque transferred to the driven pulley 230 is maximized when the rotational speed of the driven pulley 230 has high speeds (i.e. when the idler pulley 270 is at or near the position X2, and the belt 240 is positioned along the first frusto-conical surfaces 246), is neither maximized nor minimized when the rotational speed of the driven pulley 230 has low speeds (i.e. when the idler pulley is a position about halfway between the position X1 and position X2, and the belt 240 is positioned along the second frusto-conical surfaces 247), and is minimized when the driven pulley 230 is not rotating (i.e. when the idler pulley 270 is at or near the position X1, and the belt 240 is along the ring-shaped surfaces 248). As such, effectively two sets of speeds are available when using the variable-speed transmission 20, high speeds when the belt 240 is along the first frusto-conical surfaces 246 and low speeds when the belt 240 is along the second frusto-conical surfaces 247.

Additionally, a torque-sensing spring 290 can be positioned along the cable 277. The torque-sensing spring 290 serves, when necessary, to increase the amount of torque transferred to the driven pulley 230 through the belt 240 by temporarily changing the radial position of the belt 240 along the first frusto-conical surfaces 246. To illustrate, when the idler pulley 270 is in position X2, and the belt 240 is positioned in the closest-permitted position to the axis of the driven pulley 230 (along the first frusto-conical surfaces 246), the driven pulley 230, and hence, the wheels operatively interconnected therewith are rotating at a high speed. However, although torque, as discussed above, is efficiently transferred to the driven pulley 230 when the belt 240 is in substantial contact with the first frusto-conical surfaces 246, the amount of torque actually transferred is relatively small. As such, when the wheels are operating at a high speed, there may not be enough torque supplied to the wheels for the lawnmower to overcome obstacles such as sloping hills.

The torque-sensing spring 290 is provided to allow the variable-speed transmission 18 to “downshift,” and automatically supply additional torque to wheels rotating a high speeds when such additional torque is required. For example, if the wheels are rotating at a high speed, and the lawnmower encounters an obstacle, the rotation of the wheels and, hence, the driven pulley 230 will slow. When slowing, the driven pulley 230 generates a frictional force which resists the movement of the belt 240. The frictional force is translated through the driven pulley 230 to the idler bracket 271, which forces the idler bracket 271 to pull against the cable 277.

In response to the pull of the idler bracket 271, the torque-sensing spring 290 automatically lengthens to increase the effective length of the cable 277. The increase in the effective length of the cable 277 allows the idler bracket 271 to move from its original position slightly toward the first position X1, thereby temporarily increasing radial position of the belt 240 around the driven pulley 230. As the radial position of the belt 240 around the driven pulley 230 increases, the amount of torque transferred to the driven pulley 230 (and, thereafter, supplied to the wheels) increases. Once the obstacle is overcome, the resistance between the driven pulley 230 and belt 240 decreases, and the idler bracket 271 returns to its original position. As such, the torque-sensing spring 290 serves to insure that, when necessary, additional torque is supplied to the wheels.

Thus, it should be evident that the transmissions disclosed herein constitute advantageous contributions to the art.

It will be understood that the embodiment(s) described herein is/are merely exemplary and that a person skilled in the art may make many variations and modifications without departing from the spirit and scope of the invention. All such modifications and variations are intended to be included within the scope of the invention as described herein. It should be understood that the embodiments described above are not only in the alternative, but can be combined.

1. A transmission comprising, a housing and a gear assembly supported by said housing, said gear assembly including a shaft carried by said housing, a bull gear attached to said shaft, and a helical gear shaft carried by said housing, wherein said helical gear shaft incorporates a helical gear operatively connected to said bull gear.

2. A transmission according to claim 1, wherein said housing includes a first segment and a second segment, said shaft being supported in a cylindrical cavity formed between said first segment and said second segment, and said helical gear shaft extending through a hole provided in said first segment, and being supported in a receiver formed in said second segment.

3. A transmission according to claim 2, wherein said hole provided through said first segment includes serrated edges, and said receiver formed in said second segment includes serrated edges, said serrated edges capable of being coined to selectively fit the shape of said helical gear shaft, or a bearing supporting said helical gear shaft.

4. A transmission according to claim 2, further comprising a first interface surface provided on said first segment, a second interface surface provided on said second segment, and radiused beads tracing said first interface surface and said second interface surface, said radiused beads interfacing when said housing is assembled.

5. A transmission according to claim 4, wherein said first segment and said second segment each include a bull gear sub-housing, at least one of said bull gear sub-housings having a threaded hole serving as a grease port.

6. A transmission according to claim 1, wherein said bull gear and said helical gear adapted for rotating in a normal direction and in a direction opposite to said normal direction.

7. A transmission according to claim 1, wherein the transmission is a single-speed transmission, and further comprising a pulley attached to said helical gear shaft, and a belt wrapped around said pulley.

8. A transmission according to claim 7, wherein the transmission is capable of pivotal movement between a first position and a second position, said belt having substantial contact with said pulley in said first position, and said belt having limited contact with said pulley in said second position.

9. A transmission according to claim 8, wherein said pulley includes a first pulley half and a second pulley half, said first pulley half and said second pulley half each having engagement surfaces.

10. A transmission according to claim 9, wherein said engagement surfaces include at least one frusto-conical surface, and a ring-shaped surface extending outwardly from said at least one frusto-conical surface.

11. A transmission according to claim 10, wherein said belt has substantial contact with said engagement surfaces when the transmission is in said first position, and said belt had limited contact with said ring-shaped surfaces when the transmission is in said second position.

12. A transmission according to claim 1, wherein the transmission is a variable-speed transmission, and further comprising a driven pulley supported by said helical gear shaft, an idler pulley pivotably attached to the housing, and a belt wrapped around said driven pulley and said idler pulley.

13. A transmission according to claim 12, wherein said idler pulley is capable of pivotal movement between a first position and a second position, said belt having limited contact with said driven pulley when said idler pulley is in said first position and having substantial contact with said driven pulley when said idler pulley is in said second position.

14. A transmission according to claim 13, wherein said driven pulley includes a first pulley half and a second pulley half separable from one another, said first pulley half and second pulley half both having compound engagement surfaces, each of said compound engagement surfaces including at least one frusto-conical surface, and a ring-shaped surface extending outwardly from said at least one frusto-conical surface.

15. A transmission according to claim 14, wherein said belt has limited contact with said ring-shaped surfaces when said idler pulley is in said first position and has substantial contact with said compound engagement surfaces when said idler pulley is in said second position.

16. A transmission according to claim 15, wherein said second pulley half is capable of axial movement along said helical gear shaft, said second pulley half being in an upward position when said idler pulley is in said first position and said second pulley half being in a downward position when said idler pulley is in said second position, said belt being located in the farthest permitted radial location relative to said pulley when said idler pulley is in said first position, and said belt being located in the closest permitted radial location relative to said pulley when said idler pulley is in said second position.
